(19) United States
(12) Patent Application Publication
(10) Pub. No.: US 2014/0377526 A1
(43) Pub. Date: Dec. 25, 2014

(54) COMPOSITE FIBRE PANEL

(71) Applicant: KNAUF INSULATION, Vise (BE)

(72) Inventors: Gorazd Sebenik, Mont-Saint-Guibert (BE); Jure Sumi, Mont-Saint-Guibert (BE); Miha Kese, Mont-Saint-Guibert (BE); Tomaz Luznik, Mont-Saint-Guibert (BE)

(21) Appl. No.: 14/375,957

(22) PCT Filed: Feb. 1, 2013
(86) PCT No.: PCT/EP2013/052103

§ 371 Date: Jul. 31, 2014

(30) Foreign Application Priority Data
Feb. 3, 2012 (GB) 1201885.9

(51) Int. Cl. G10K 11/162; B32B 27/40; E06B 5/20; B32B 15/04; E06B 3/70; B32B 5/18; B32B 21/04

(52) U.S. Cl. CPC G10K 11/162; B32B 5/18; B32B 27/40; B32B 21/047; B32B 15/046; E06B 3/7015; E06B 5/20; B32B 2250/03; B32B 2307/102; E06B 2003/7023
USPC 428/220; 428/317.9; 252/62

(57) ABSTRACT

A composite fibre panel comprising: between 20% and 70% by weight mineral fibres; and between 30% and 80% polymeric material; and in which the polymeric material comprising polymeric material in particulate form may be used to provide improved acoustic and/or fire performances.

This invention relates to a composite fibre panel, in particular an acoustic panel, especially for use in door constructions, floor insulation or sandwich panels.

One known form of panel used in doors comprises a mixture of coconut fibres, polyurethane (PU) foam, particulate rubber and glue. The heterogeneous nature of these panels contributes to their good sound absorbing properties and the availability of their constituent parts allows their manufacture at moderate cost.

U.S. Pat. No. 4,256,803A discloses a panel having an expanded phenolic resin core incorporating fillers and a polycondensed phenolic resin layer outer covering layer which is reinforced with glass fibre fabric.

JP2009052033 discloses a thermoplastic resin composition for expansion moulding which incorporates wood flour and a filler.

The panels disclosed in U.S. Pat. No. 4,256,803A and JP2009052033 are not adapted to provide advantageous sound absorbing properties, nor to be used in the specific applications envisaged for the present invention.

One aim of the present invention is to provide panels which can match the acoustic performance and cost of known panels but also provide additional advantages.

According to one aspect, the present invention provides a composite fibre panel as defined in claim 1. Other aspects are defined in other dependent claims whilst the dependent claims define preferred and/or alternative embodiments.

The use of mineral fibres, for example stone wool fibres or glass wool fibres, in the quantities specified may be used to confer advantageous fire resistance and/or good levels of compressive strength and/or low thermal conductivity upon the panels. Each of these properties, either individually or combined, is particularly useful when the composite panels are used in doors or sandwich panels.

The combination of different materials in the composite fibre panels contributes to their ability to absorb sound and thus to their acoustic performance. A foam material included as part of the polymeric material serves such a purpose as does a polymeric material in particulate form and as does the combination of these materials. The foam may have a closed cell structure or an open cell structure or a combination thereof; it may comprise polyurethane foam, expanded polystyrene foam (EPS), extruded polystyrene foam (XPS) or mixtures thereof. The polymeric material in particulate form may be in the form of particles, preferably particles of different sizes, and may be provided as scraps or recycled material; the polymeric material in particulate form may comprise rubber(s), natural rubber(s), synthetic rubber(s), polyurethane, elastomer(s) or mixtures thereof. The mean geometric diameter of the polymeric material in particulate form may be ≧0.1 mm or ≧0.2 mm or ≧0.5 mm or ≧1 mm or ≧2 mm. The mean geometric diameter of the polymeric material in particulate form may be ≦30 mm or ≦20 mm or ≦10 mm or ≦5 mm.

The provision of a composite fibre panel having a height of at least 160 cm and a width of at least 60 cm allows the panel to be used without requiring additional panels to fill the cavity of a fire rated door. Handling and assembling a single panel is easier and more efficient than dealing with multiple different panels. In addition, the provision of a single or unitary panel having dimensions that can fill the entire cavity of a door avoids the risk of a point of weakness or a thermal bridge in the insulation that would occur at the abutments of separate but adjoining panels. The panel may be substantially rectangular; it may be provided with preformed cuts and/or cut-outs to facilitate its assembly in a door cavity. The panel may be provided as a single or as a multilayer arrangement, for example of two or more superposed panels.

The dimensions of the composite fibre panel may be:
height ≧160 cm, optionally ≧180 cm or ≧200 cm and/or ≦300 cm, optionally ≦260 cm or ≦230 cm;
width ≧60 cm, optionally ≧70 cm or ≧80 cm and/or ≦200 cm, optionally ≦140 cm or ≦100 cm;
thickness preferably ≧1 cm, optionally ≧1.5 cm or ≧2 cm and/or preferably ≦12 cm, optionally ≦10 cm or ≦8 cm

The composite fibre panel is particularly suited for use in doors, particularly in fire rated doors and even more particularly in doors meeting a Ei 30, Ei45 or Ei 60, fire class. The doors may be functional doors. In one embodiment, the doors comprise peripheral wooden skins or wooden external panels or cover plates which define an internal door cavity in which the composite fibre panel is arranged. Each wooden cover plate may have a thickness ≧2 mm, notably ≧2.5 mm or ≧3 mm and/or ≧8 mm notably ≦5 mm or ≦4.5 mm. The cover plates may be of chipboard or medium density fibre board (MDF) and may comprise a veneer.

In an alternative embodiment the doors comprise peripheral sheet metal skins or sheet metal external panes, notably of steel, which define an internal door cavity in which the composite fibre panel is arranged.

The doors may have a door leaf thickness ≧30 mm, notably ≧35 mm or ≧40 mm and/or ≦100 mm notably ≦75 mm or ≦50 mm. The door leaf weight in kg/m² may be thickness ≧10, notably ≧15 or ≧20 and/or ≦100 notably ≦70 or ≦40.

The density of the composite fibre panels may be:
at least 300 kg/m³; notably at least 400 kg/m³ or at least 500 kg/m³; and/or
not more than 800 kg/m³, notably not more than 700 kg/m³ or 600 kg/m³.

The polymeric material in the form of a foam may have a density ≦60 kg/m³, ≦50 kg/m³, or notably ≦40 kg/m³; it may have a density ≧5 kg/m³, ≧10 kg/m³ or notably ≧20 kg/m³. Foams having such densities may be referred to as “light foams”. The composite fibre panels may comprise a hard foam, for example a foam having a density ≧60 kg/m³, ≧80 kg/m³ or notably ≧100 kg/m³ and/or ≦160 kg/m³, or notably ≦150 kg/m³.

Such densities may contribute to the compressive strength and/or fire performance and thus facilitate use in doors, floor applications and/or sandwich panels for structural applications.

The compressive strength of the composite fibre panels may be at least 300 kPA, notably at least 350 kPA, at least 400 kPA, at least 450 kPA or at least 500 kPA when tested according EN 826. Such compressive strength facilitates use in doors and/or sandwich panels for structural applications.

The thickness of the composite fibre panels may be at least 15 mm, notably at least 20 mm, at least 25 mm, at least 30 mm, at least 40 mm or at least 50 mm; it may be no more than 250 mm, notably no more than 200 mm. Such thicknesses are suitable for use in doors and/or sandwich panels for structural applications.

The thermal conductivity of the composite fibre panels may be less than 0.130 W/mK, notably less than 0.110 W/mK, less than 0.105 W/mK, less than 0.100 W/mK, preferably less than 0.095 W/mK.

The composite fibre panels may also comprise one or more additives for example: small stones (dolomites, quartz sand), paper. Such additives may be derived from recycled materials and/or provided in particulate form, notably having a mean geometric diameter ≧0.1 mm or ≧0.2 mm or ≧0.5 mm or ≧1 mm or ≧2 mm and/or ≦10 mm or ≦5 mm.

The presence of the polymeric material preferably reduces sound transmission in the range from 50 to 5000 Hz. The characteristic(s) (notably diameter, length, density, composition, quantity) of the polymeric material in particulate form, of the polymeric material in the form of the foam of the mineral fibres or of the additives and the characteristic of the composite fibre panel (thickness) may be used to control the sound transmission of the composite fibre panel. Any combination of these different characteristics may be used to control the amplitude and/or and frequency of sound transmitted through the panel.

The invention also relates to doors and panels which comprise composite fibre panels according to the invention.

Such doors and panels may have:
a sound insulation category of at least SSK3, preferably SSK2, more preferably SSK1; and/or
a sound isolation on the facility R_{W,R (DIN 4109)} of at least 35-39 dB, preferably 30-34 dB, more preferably 25-29 dB; and/or
a laboratory sound isolation R_{W (EN ISO 140-3)} of at least minimum 42 dB, preferably minimum 37 dB, more preferably minimum 32 dB;
   particularly for doors or panels comprising the construction:
   wooden facing 2-6 mm thick (notably about 3-4.5 mm thick)/composite fibre panel 15-60 mm thick (notably about 25-50 mm thick, particularly 30-45 mm thick)/wooden facing 2-6 mm thick (notably about 3-4.5 mm thick).

Embodiments of the invention will now be described, by way of example only.

Composite fibre boards were produced having the following compositions:

| | Examples | | |
|---|---|---|---|
| | Comparative | Examples 1a | Examples 2a |
| Material (% weight) | examples | and 1b | and 2b |
| Coconut fibres | 50% | 0% | 0% |
| Stone wool mineral fibres | 0% | 32% | 52% |
| Polymeric material being | 50% | 68% | 48% |
| i) PU foam | 15% | 22% | 10% |
| ii) Rubber in particular form | 25% | 38% | 26% |
| iii) binder (glue) | 10% | 8% | 12% |

and the following properties:

| | | Examples | | | | | |
|---|---|---|---|---|---|---|---|
| | | Comparative examples | | Examples 1a and 1b | | Examples 2a and 2b | |
| | | Ca (single | Cb (double | 1a (single | 1b (double | 2a (single | 2b (double |
| parameter | unit | layer) | layer) | layer) | layer) | layer) | layer) |
| thickness | mm | 20 | 36.8 | 23.8 | 43.2 | 23.7 | 43.1 |
| density | kg/m3 | 525 | 585 | 492 | 526 | 452 | 495 |
| Thermal | W/mK | 0.1175 | 0.1146 | 0.0973 | 0.0943 | 0.0902 | 0.0879 |
| conductivity λ | | | | | | | |

| | | | | |
|---|---|---|---|---|
| Compressive | kPa | 340 | 688 | 520 |
| Strength | | | | |
| (average) | | | | |

The boards were produced by thoroughly mixing the materials together and allowing the binder to cure. Due to the thorough mixing, the mineral fibres and the polymeric material are present through the core of the board, and preferably through the entire thickness of the board.

Two sandwich panels were produced, each having a thin steel sheet 1.0 mm thick adhered to each major surface of a fibre board in accordance with example 2a. When assembled, these sandwich panels had a core thickness of 20 mm. When subjected to a fire resistance test according to EN 1363-1 these panels achieved a fire rating of 37 minutes. By comparison, a similar sandwich panel constructed with a core according to Comparative example Cb started burning after 15 minutes when subjected to this test.

1. A composite fibre panel having a core comprising:
between 20% and 70% by weight of mineral fibres; and
between 30% and 80% by weight of polymeric material;
and in which the polymeric material comprises polymeric material in particulate form and polymeric material in the form of a foam.

2. The composite fibre panel of claim 1, in which the panel comprises between 10% and 30% by weight foam, preferably polyurethane foam.

3. The composite fibre panel of claim 1, in which the polymeric material in particulate form comprises one or more materials selected from the group consisting of elastomers, rubbers, natural rubbers, and synthetic rubbers.

4. The composite fibre panel of claim 1, in which the panel comprises between 10% and 30% by weight of polymeric material in particulate form.

5. The composite fibre panel of claim 1, in which the panel comprises an additional binder making up between 5% and 15% by weight of the panel.

6. The composite fibre panel of claim 1, in which mineral wool fibres are stone wool fibres having an average diameter in the range of 2-10 μm and an average length in the range 2-30 mm.

7. The composite fibre panel of claim 1, in which the composite fibre panel has a thickness of at least 15 mm.

8. The composite fibre panel of claim 1, in which the composite fibre panel has a height of at least 160 cm and a width of at least 60 cm.

9. The composite fibre panel of claim 1, in which the composite fibre panel has a density in the range 300 kg/m³ to 800 kg/m³.

10. The composite fibre panel of claim 1, in which the composite fibre panel has a compression strength of at least 300 kPa.

11. The composite fibre panel of claim 1, in which the composite fibre panel has a thermal conductivity of not more than 0.130 W/mK.

12. A panel comprising the composite fibre panel of claim 1 having a sheet material secured to each of its two major surfaces, in which the composite fibre panel is sandwiched between two sheet plates selected from wooden plates and metal plates.

13. The panel of claim 12, in which the sandwich panel has a fire class of at least Ei30.

14. A door comprising the composite fibre panel of claim 1 and having a fire class of at least Ei30.

15. A door comprising the composite fibre panel of claim 1, in which the door has
a sound insulation category of at least SSK3, SSK2, or SSK1; and/or
a sound isolation RW,R (DIN 4109) of at least 35-39 dB, 30-34 dB, or 25-29 dB; and/or
a laboratory sound isolation RW (EN ISO 140-3) of at least minimum 42 dB, minimum 37 dB, or minimum 32 dB.

16. The composite fibre panel of claim 7, in which the composite fibre panel has a thickness of at least 20 mm.

17. A method for manufacturing a composite fibre panel comprising thoroughly mixing:
a) between 20% and 70% by weight of mineral fibres;
b) between 30% and 80% by weight of polymeric material in which the polymeric material comprises polymeric material in particulate form and polymeric material in the form of a foam; and
c) a binder;
and allowing the binder to cure.
